(19) United States
(12) Patent Application Publication
(10) Pub. No.: US 2025/0357815 A1
(43) Pub. Date: Nov. 20, 2025

(54) ELECTRIC COMPRESSOR

(71) Applicant: SANDEN CORPORATION, Gunma (JP)

(72) Inventors: Toru SHIMADA, Gunma (JP); Tatsuki KASHIHARA, Gunma (JP)

(21) Appl. No.: 18/871,355

(22) PCT Filed: May 26, 2023
(86) PCT No.: PCT/JP2023/019689

§ 371 Date: Dec. 3, 2024

(30) Foreign Application Priority Data
Jun. 20, 2022 (JP) 2022-098554

(51) Int. Cl. H02K 3/50; F25B 31/02; H02K 5/04; H02K 11/33

(52) U.S. Cl. CPC H02K 3/50; F25B 31/02; H02K 5/04; H02K 11/33

(57) ABSTRACT

An electric compressor 1 includes an inverter 16 that has a plurality of switching elements 18A to 18F and supplies power to a motor 8. Included are: a housing 2 including a motor chamber 4 in which the motor is incorporated, and an inverter accommodating portion 6 in which the inverter is mounted; a partition wall 3 between the motor chamber and the inverter accommodating portion; and a plurality of connecting terminals 10A, 10B, and 10C each having one end electrically connected to the motor and protruding from the motor in a direction of the partition wall. The connecting terminals are dispersedly provided and each have the other end electrically connected to the inverter through the partition wall. The switching elements are dispersedly provided on the partition wall in such a manner as to correspond to each of the connecting terminals.

### TECHNICAL FIELD

The present invention relates to an electric compressor including an inverter that has a plurality of switching elements and supplies power to a motor.

### BACKGROUND ART

For example, an inverter-integrated electric compressor in which an inverter is mounted in an inverter accommodating portion formed in a housing is used as a refrigerant compressor used in an air conditioning system of an electric vehicle. In this case, a three-phase motor is accommodated in a motor chamber of the housing, and a glass hermetic plate (cluster) is provided on a partition wall between the motor chamber and the inverter accommodating portion.

Moreover, six switching elements (such as IGBTs) configuring the inverter are provided on the partition wall and connected to a circuit board of the inverter. Consequently, the switching elements are cooled by a low-temperature refrigerant flowing through the motor chamber via the partition wall. In other words, the housing itself serves as a heat sink for the switching elements. In addition, three hermetic pins that are aligned and mounted on the hermetic plate are electrically connected to the circuit board of the inverter. This is the structure of the above electric compressor (refer to, for example, Patent Literature 1).

### CITATION LIST

### Patent Literature

Patent Literature 1: JP-A-2015-183668
Patent Literature 2: Japanese Patent No. 4804381
Patent Literature 3: Japanese Patent No. 6574044

### SUMMARY OF INVENTION

### Problems to be Solved by Invention

However, in the known structure in which the hermetic pins are provided to the hermetic plate, distances between the hermetic pins and the switching elements are different. Therefore, a wiring length to each phase of the motor varies depending on the phase. Hence, a surge voltage changes depending on the phase. Therefore, the loss/heat generated of each switching element is not equal, which makes control difficult, and causes problems such as the switching elements having larger amounts of loss/heat generated deteriorate first.

Moreover, in recent years, widening of a voltage range has been promoted also in this type of electric compressor. For example, an inverter has also been developed which has a widened voltage range by using half bridges opposed to each other without creating a neutral point of a motor (refer to, for example, Patent Literature 2). In this case, it is necessary to place 12 switching elements on a partition wall of a housing. However, in the known structure in which the hermetic pins are mounted on the hermetic plate, there is no degree of freedom in the placement of the switching elements, and the number of hermetic pins increases. Therefore, in consideration of dielectric strength and cooling efficiency, it is difficult to place all of them on the partition wall without increasing the dimensions of the housing, which is desired to be improved.

On the other hand, an electric compressor has also been proposed in which three energizing pins (connecting terminals) protrude from a motor, penetrate a partition wall of a housing, and are connected to an inverter (refer to, for example, Patent Literature 3.).

The present invention has been made in order to solve such known technical problems, and an object thereof is to provide an electric compressor capable of equalizing losses/heat generated of switching elements and furthermore capable of widening the range without increasing the dimensions.

### Solution to Problems

An electric compressor according to the present invention includes an inverter that has a plurality of switching elements and supplies power to a motor, and includes: a housing including a motor chamber in which the motor is incorporated, and an inverter accommodating portion in which the inverter is mounted; a partition wall between the motor chamber and the inverter accommodating portion; and a plurality of connecting terminals each having one end electrically connected to the motor and protruding from the motor in a direction of the partition wall, in which the connecting terminals are dispersedly provided and each have the other end electrically connected to the inverter through the partition wall, and the switching elements are dispersedly provided on the partition wall in such a manner as to correspond to each of the connecting terminals.

In accordance with a second aspect of the invention, in the electric compressor according to the above aspect of the invention, the switching elements are located near the connecting terminals and provided on the partition wall.

In accordance with a third aspect of the invention, in the electric compressor according to the first aspect of the invention, the connecting terminals are dispersedly provided at equal intervals in a circumferential direction of the motor.

In accordance with a fourth aspect of the invention, in the electric compressor according to the above aspects of the invention, three connecting terminals are provided, the inverter includes six switching elements, and the switching elements are placed in pairs, the pairs corresponding to the connecting terminals respectively.

In accordance with a fifth aspect of the invention, in the electric compressor according to the first to third aspects of the invention, four connecting terminals are provided, the inverter includes eight switching elements, and the switching elements are placed in pairs, the pairs corresponding to the connecting terminals respectively.

In accordance with a sixth aspect of the invention, in the electric compressor according to the first or second aspect of the invention, six connecting terminals are provided, the inverter includes seven switching elements and one diode, and the switching elements and the diode are dispersedly placed in such a manner as to correspond to the connecting terminals.

In accordance with a seventh aspect of the invention, in the electric compressor according to the first to third aspects of the invention, six connecting terminals are provided, the inverter includes 12 switching elements, and the switching elements are placed in pairs, the pairs corresponding to the connecting terminals respectively.

### Effects of Invention

According to the present invention, an electric compressor including an inverter that has a plurality of switching elements and supplies power to a motor includes: a housing including a motor chamber in which the motor is incorporated, and an inverter accommodating portion in which the inverter is mounted; a partition wall between the motor chamber and the inverter accommodating portion; and a plurality of connecting terminals each having one end electrically connected to the motor and protruding from the motor in a direction of the partition wall, in which the connecting terminals are dispersedly provided and each have the other end electrically connected to the inverter through the partition wall, and the switching elements are dispersedly provided on the partition wall in such a manner as to correspond to each of the connecting terminals. Therefore, it is possible to make the values of wiring lengths to the phases of the motor the same, or nearly the same, equalize surge voltages in the phases, and equalize losses/heat generated of the switching elements.

Moreover, the degree of freedom in the placement of the switching elements increases. Therefore, also if the number of the connecting terminals and the number of the switching elements increase, it is possible to place them in a state where the dielectric strength and the cooling efficiency are satisfied, without increasing the dimensions of the housing. Consequently, it is possible to smoothly widen a voltage range.

In this case, as in the second aspect of the invention, if the switching elements are located near the connecting terminals and provided on the partition wall, it is possible to reduce the wiring lengths from the switching elements to the connecting terminals and reduce the surge voltages.

Moreover, as in the third aspect of the invention, if the connecting terminals are dispersedly provided at equal intervals in the circumferential direction of the motor, it is possible to smoothly encourage the equalization of the wiring length to each phase of the motor.

Specifically, if three connecting terminals are provided and the inverter includes six switching elements, the switching elements are placed in pairs, the pairs corresponding to the connecting terminals respectively, as in the fourth aspect of the invention.

Moreover, also if four connecting terminals are provided and the inverter includes eight switching elements, the switching elements are placed in pairs, the pairs corresponding to the connecting terminals respectively, as in the fifth aspect of the invention.

Furthermore, if six connecting terminals are provided and the inverter includes seven switching elements and one diode, the switching elements and the diode are dispersedly placed in such a manner as to correspond to the connecting terminals as in the sixth aspect of the invention.

In addition, also if six connecting terminals are provided and the inverter includes 12 switching elements, the switching elements are preferably placed in pairs, the pairs corresponding to the connecting terminals respectively, as in the seventh aspect of the invention.

### BRIEF DESCRIPTION OF DRAWINGS

FIG. 1 is a schematic vertical cross-sectional view of an electric compressor of an example to which the present invention is applied.

FIG. 2 is an electric circuit diagram of an example of the electric compressor of FIG. 1 (Example 1).

FIG. 3 is a plan view of the electric compressor of the example of FIG. 2, excluding a cover and a board, as viewed from an inverter accommodating portion.

FIG. 4 is a diagram for explaining the operation of an inverter of the example of FIG. 2.

FIG. 5 is an electric circuit diagram of another example of the electric compressor of FIG. 1 (Example 2).

FIG. 6 is a plan view of the electric compressor of the example of FIG. 5, excluding a cover and a board, as viewed from an inverter accommodating portion side.

FIG. 7 is a diagram for explaining the operation of an inverter of the example of FIG. 5.

FIG. 8 is an electric circuit diagram of still another example of the electric compressor of FIG. 1 (Example 3).

FIG. 9 is a plan view of the electric compressor of the example of FIG. 8, excluding a cover and a board, as viewed from an inverter accommodating portion side.

FIG. 10 is a diagram for explaining the operation of an inverter of the example of FIG. 8.

FIG. 11 is an electric circuit diagram of yet another example of the electric compressor of FIG. 1 (Example 4).

FIG. 12 is a plan view of the electric compressor of the example of FIG. 11, excluding a cover and a board, as viewed from an inverter accommodating portion side.

FIG. 13 is a diagram for explaining the operation of an inverter of the example of FIG. 11.

### DESCRIPTION OF EMBODIMENTS

Embodiments of the present invention are described in detail hereinafter with reference to the drawings.

### Example 1

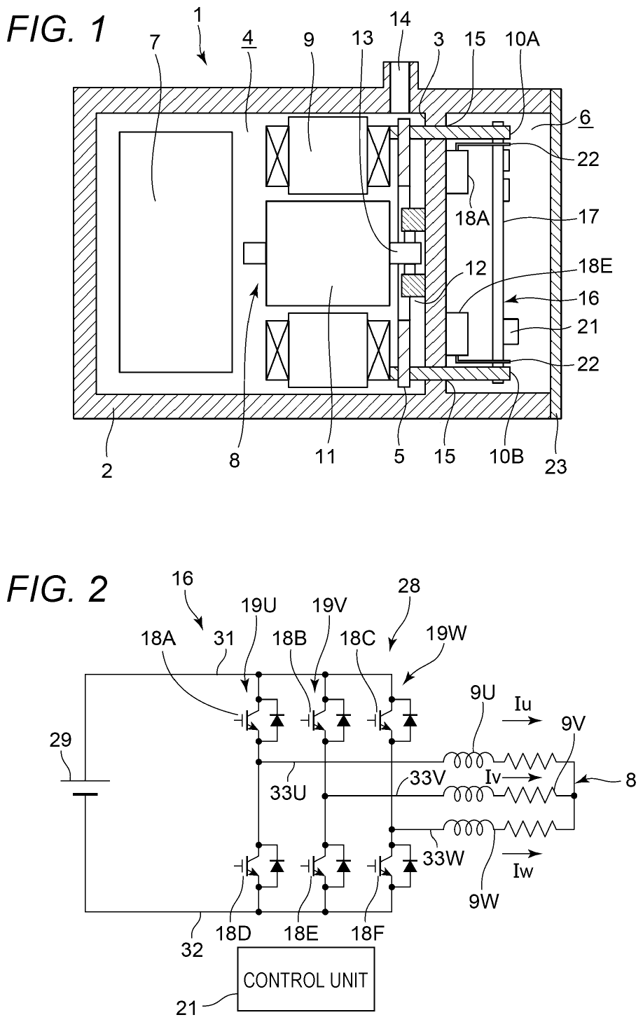

Firstly, an electric compressor (inverter-integrated electric compressor) 1 of an example to which the present invention is applied is described with reference to FIGS. 1 to 4. Note that the electric compressor 1 of the example configures part of a refrigerant circuit of a vehicle air-conditioning system that is installed on an electric vehicle.

### (1) Structure of Electric Compressor 1

In FIG. 1, the inside of a metal (aluminum in the example) housing 2 (a heat sink) of the electric compressor 1 is divided into a motor chamber 4 and an inverter accommodating portion 6 by a partition wall 3 (part of the housing 2) intersecting with an axial direction of the housing 2, and, for example, a scroll compression mechanism 7 and a motor 8 (an electric motor) that drives the compression mechanism 7 are accommodated in the motor chamber 4. In the case of the example, the motor 8 is an IPMSM (Interior Permanent Magnet Synchronous Motor) including a stator 9 fixed to the housing 2 and a rotor 11 that rotates inside the stator 9.

A bearing portion 12 is formed in a central portion on a motor chamber 4 side of the partition wall 3, the bearing portion 12 supports one end of a drive shaft 13 of the rotor 11, and the other end of the drive shaft 13 is coupled to the compression mechanism 7. An inlet 14 is formed near the partition wall 3 at a position corresponding to the motor chamber 4 of the housing 2. When the rotor 11 (the drive shaft 13) of the motor 8 rotates to drive the compression mechanism 7, a low-temperature refrigerant that is working fluid flows into the motor chamber 4 of the housing 2 through the inlet 14, and is sucked into and compressed by the compression mechanism 7.

It is configured in such a manner that the refrigerant that has been compressed by the compression mechanism 7 to increase in temperature and pressure is then discharged to the refrigerant circuit outside the housing 2 through an unillustrated outlet. Moreover, the low-temperature refrigerant flowing through the inlet 14 passes near the partition wall 3 and passes around the motor 8, and is sucked into the compression mechanism 7, which results in also cooling the partition wall 3.

Moreover, in the example, a bus bar 5 is mounted on coil ends on the partition wall 3 side of the stator 9. The bus bar 5 has an annular shape, and is electrically connected to U-, V-, and W-phase coils 9U, 9V, 9W (FIG. 2) wound around the stator 9 of the motor 8. Moreover, three connecting terminals 10A, 10B, and 10C are mounted on the bus bar 5 in this example, and provided, protruding in a direction of the partition wall 3. One ends of the connecting terminals 10A, 10B, and 10C are electrically connected to their respective coils 9U, 9V, and 9W of the phases of the motor 8 via the bus bar 5.

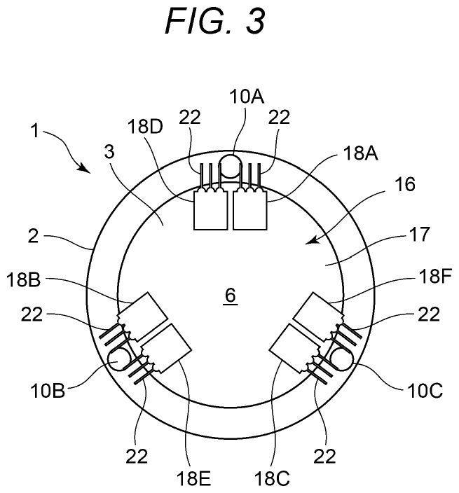

In the case of the example, the connecting terminals 10A, 10B, and 10C are dispersedly provided at equal intervals (spaced an angle of 120° apart around the axis of the housing 2) in a circumferential direction of the motor 8. Moreover, insertion holes 15 are formed in the partition wall 3 at positions corresponding to the connecting terminals 10A, 10B, and 10C (in three places) respectively. In addition, the connecting terminals 10A, 10B, and 10C pass through their respective insertion holes 15, that is, penetrate the partition wall 3, and the other ends of the connecting terminals 10A, 10B, and 10C enter the inverter accommodating portion 6. This state is illustrated in FIG. 3. Note that spaces between the through holes 15 and the connecting terminals 10A, 10B, and 10C are insulated and sealed with, for example, unillustrated O-rings.

### (2) Structure of Inverter 16

In addition, an inverter 16 that controls the drive of the motor 8 is accommodated in the inverter accommodating portion 6 divided from the motor chamber 4 by the partition wall 3. In the case of this example, the inverter 16 includes a board 17, six upper and lower arm switching elements 18A to 18F located on one side (a partition wall 3 side) relative to the board 17 and wired to the board 17, a control unit 21 wired on the other side of the board 17, and an unillustrated HV connector and LV connector. Each of the switching elements 18A to 18F includes an insulated-gate bipolar transistor (IGBT) of which the gate portion incorporates a MOS structure in the example.

The other ends of the connecting terminals 10A, 10B, and 10C that have entered the inverter accommodating portion 6 through the partition wall 3 are electrically connected to the board 17 of the inverter 16 via, for example, unillustrated press-fit terminals. In addition, in the case of the example, as illustrated in FIG. 3, the upper arm switching element 18A and the lower arm switching element 18D, which configure a U-phase half bridge circuit 19U of a three-phase inverter circuit (three-phase inverter circuit) 28 described below, are located near the left and right sides of the connecting terminal 10A, and are placed in heat exchange relationship on an inverter accommodating portion 6-side surface of the partition wall 3.

Moreover, the upper arm switching element 18B and the lower arm switching element 18E, which configure a V-phase half bridge circuit 19V of the inverter circuit 28, are located near the left and right sides of the connecting terminal 10B, and are placed in heat exchange relationship on the inverter accommodating portion 6-side surface of the partition wall 3. Furthermore, the upper arm switching element 18C and the lower arm switching element 18F, which configure a W-phase half bridge circuit 19W of the inverter circuit 28, are located near the left and right sides of the connecting terminal 10C, and are placed in heat exchange relationship on the inverter accommodating portion 6-side surface of the partition wall 3.

As described above, in the example, the switching elements 18A to 18F are dispersedly placed in pairs, the pairs corresponding to the connecting terminals 10A to 10C respectively, and are provided on the partition wall 3. Moreover, terminal portions 22 of the switching elements 18A to 18F are set upright toward the board 17, facing the connecting terminals 10A to 10C, and are electrically connected to the board 17 of the inverter 16. As described above, the inverter 16 including the inverter circuit 28 is configured in such a manner as to supply power to the motor 8 via the connecting terminals 10A to 10C and the bus bar 5.

Moreover, the switching elements 18A to 18F are in close contact with the partition wall 3 via an unillustrated sheet for insulation and/or heat dissipation to have a heat exchange relationship with the partition wall 3 of the housing 2. At this point in time, the switching elements 18A to 18F are placed at positions avoiding places corresponding to the bearing 12 and the drive shaft 13. In addition, the partition wall 3 is cooled by the refrigerant sucked into the motor chamber 4 as described above. Therefore, the switching elements 18A to 18F have a heat exchange relationship with the sucked refrigerant via the partition wall 3, and are cooled by the refrigerant sucked into the motor chamber 4 via the partition wall 3. The switching elements 18A to 18F themselves dissipate heat to the refrigerant via the partition wall 3. In other words, the partition wall 3 (part of the housing 2) of the electric compressor 1 serves as a heat sink for the switching elements 18A to 18F.

### (3) Circuit Configuration of Inverter 16

Next, in FIG. 2, the inverter 16 includes the above-mentioned three-phase inverter circuit (three-phase inverter circuit) 28 and control unit 21. The inverter circuit 28 is a circuit that converts direct current voltage (for example, 300 V DC) of a direct current power supply (a battery of the electric vehicle) 29 to three-phase alternating current voltage and applies the three-phase alternating current voltage to the coils 9U, 9V, and 9W of the stator 9 of the motor 8. Note that the coils 9U, 9V, 9W of the stator 9 of the motor 8 of this example are bundled at the neutral point.

The inverter circuit 28 includes the above-mentioned U-phase half bridge circuit 19U, V-phase half bridge circuit 19V, and W-phase half bridge circuit 19W. The half bridge circuits 19U to 19W of the phases individually include the above-mentioned upper arm switching elements 18A to 18C and lower arm switching elements 18D to 18F. Furthermore, each of the switching elements 18A to 18F incorporates a flywheel diode connected in anti-parallel thereto.

Collector electrodes of the upper arm switching elements 18A to 18C of the inverter circuit 28 are connected to a positive power supply line 31 (HV+) of the direct current power supply 29. On the other hand, emitter electrodes of the lower arm switching elements 18D to 18F of the inverter circuit 28 are connected to a negative power supply line 32 (HV−) of the direct current power supply 29.

In addition, an emitter electrode of the upper arm switching element 18A and a collector electrode of the lower arm switching element 18D of the U-phase half bridge circuit 19U are connected together, and their connection point (an arm midpoint) is connected to one end of the U-phase coil 9U of the motor 8. Moreover, an emitter electrode of the upper arm switching element 18B and a collector electrode of the lower arm switching element 18E of the V-phase half bridge circuit 19V are connected together, and their connection point (an arm midpoint) is connected to one end of the V-phase coil 9V of the motor 8. Furthermore, an emitter electrode of the upper arm switching element 18C and a collector electrode of the lower arm switching element 18F of the W-phase half bridge circuit 19W are connected together, and their connection point (an arm midpoint) is connected to one end of the W-phase coil 9W of the motor 8. Note that the other ends of the coils 9U to 9W are bundled to create a neutral point as described above.

The above-mentioned connecting terminal 10A is part of wiring 33U between the connection point of the upper arm switching element 18A and the lower arm switching element 18D of the U-phase half bridge circuit 19U, and the U-phase coil 9U of the motor 8. Moreover, the connecting terminal 10B is part of wiring 33V between the connection point of the upper arm switching element 18B and the lower arm switching element 18E of the V-phase half bridge circuit 19V, and the V-phase coil 9V of the motor 8. Furthermore, the connecting terminal 10C is part of wiring 33W between the connection point of the upper arm switching element 18C and the lower arm switching element 18F of the W-phase half bridge circuit 19W, and the W-phase coil 9W of the motor 8.

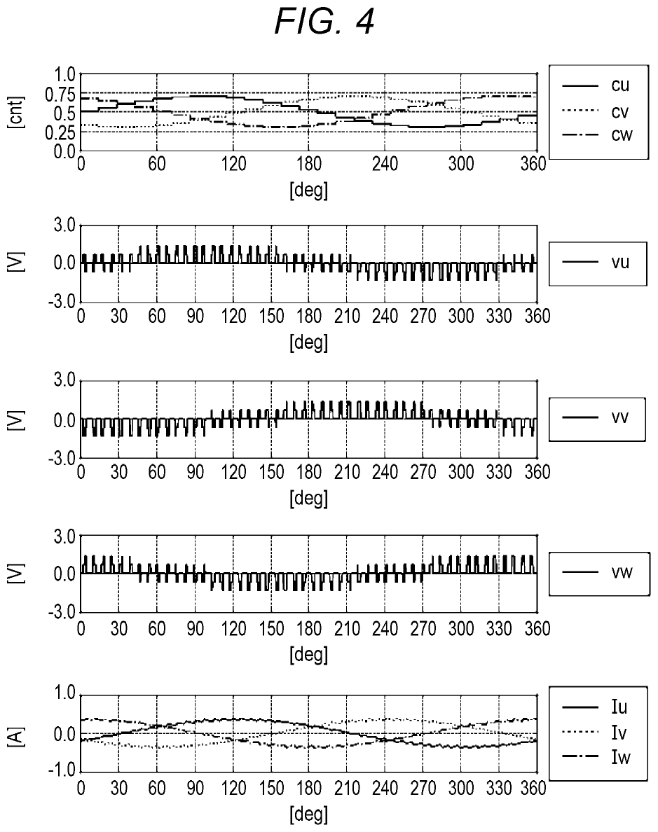

Next, FIG. 4 illustrates a control operation example of the control unit 21 of the inverter 16 in this example. In this drawing, cu, cv, and cw are normalized pulse width command values, and vu, vv, and vw are the voltages applied to the U, V, and W phases of the motor 8 respectively. Moreover, Iu, Iv, and Iw are examples of the currents flowing through the motor 8.

The control unit 21 switches (ON/OFF) the switching elements 18A to 18F of the half bridge circuits 19U, 19V, and 19W of the phases of the inverter circuit 28 to apply the three-phase alternating current voltages vu, vv, and vw to the coils 9U, 9V, and 9W of the motor 8 respectively. In FIG. 4, normalization is performed in such a manner that “1” is applied when the upper arm switching elements 18A to 18C are ON, and “−1” is applied when the lower arm switching elements 18D to 18F are ON. Moreover, vu, vv, and vw are expressed in value obtained by subtracting neutral-point potential vmid of the motor 8 from an output voltage of the inverter circuit 16.

As illustrated in FIG. 4, the inverter 16 applies the three-phase alternating current voltages to the motor 8 to rotationally drive the motor 8. At this point in time, in the present invention, as described above, the three connecting terminals 10A to 10C that are provided, protruding from the motor 8 in the direction of the partition wall 3, are dispersedly provided, the other ends thereof penetrating the partition wall 3 are electrically connected to the inverter 16, and the switching elements 18A to 18F are dispersedly provided on the partition wall 3 in such a manner as to correspond to the connecting terminals 10A to 10C. Therefore, the values of the lengths (wiring lengths) of the wirings 33U to 33W to the phases of the motor 8 can be made the same or nearly the same. This makes it possible to equalize surge voltages in the U, V, and W phases and equalize the losses/heat generated of the switching elements 18A to 18F.

Moreover, in the example, the switching elements 18A to 18F are provided in pairs on the partition wall 3 in such a manner that the pairs correspond to the connecting terminals 10A to 10C respectively, and are located near the connecting terminals 10A to 10C. Therefore, the wiring length from the switching elements 18A and 18D to the connecting terminal 10A, the wiring length from the switching elements 18B and 18E to the connecting terminal 10B, and the wiring length from the switching elements 18C and 18F to the connecting terminal 10C are reduced, and the surge voltages can be further reduced.

Moreover, in the example, the connecting terminals 10A to 10C are dispersedly provided at equal intervals in the circumferential direction of the motor 8. Therefore, it is possible to smoothly encourage the equalization of the wiring lengths (the lengths of the wirings 33U to 33W) to the U, V, and W phases of the motor 8.

### Example 2

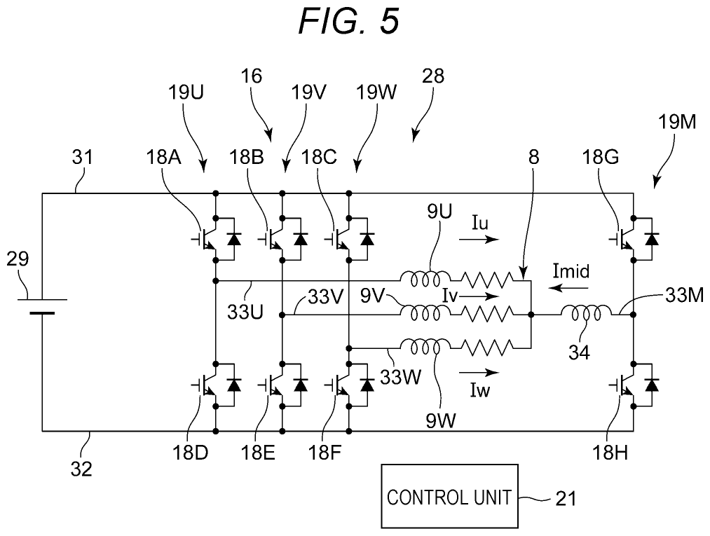

Next, another example of the present invention is described with reference to FIGS. 5 to 7. Note that the structure of a target electric compressor 1 is similar to the one of FIG. 1, and those denoted by the same reference signs as those of FIGS. 1 to 4 are assumed to exert the same or similar functions. The inverter 16 of this example is a four-wire inverter, and the inverter circuit 28 includes two switching elements 18G and 18H configuring a fourth half bridge circuit 19M in addition to the six switching elements 18A to 18F of the above-mentioned example (Example 1) (FIG. 5).

In other words, the inverter circuit 28 of the inverter 16 of this example includes eight switching elements 18A to 18H in total. In this case, a collector electrode of the upper arm switching element 18G of the fourth half bridge circuit 19M is connected to the positive power supply line 31, and an emitter electrode of the lower arm switching element 18H is connected to the negative power supply line 32.

In addition, an emitter electrode of the upper arm switching element 18G and a collector electrode of the lower arm switching element 18H of the half bridge circuit 19M are connected together, and their connection point (an arm midpoint) is connected to the neutral point of the motor 8 via an exciting coil 34.

As described above, the inverter 16 of this example includes the eight switching elements 18A to 18H. Therefore, also in terms of connecting terminals, one more connecting terminal 10D is provided in addition to the above-mentioned three connecting terminals 10A to 10C. Note that the connecting terminal 10D is also mounted on the bus bar 5, and one end thereof is electrically connected to the neutral point of the motor 8 via the bus bar 5. Moreover, the connecting terminal 10D also protrudes from the bus bar 5, passes the similar insertion hole 15 in the partition wall 3 (penetrates the partition wall 3), and is electrically connected to the board 17 of the inverter 16 via, for example, a press-fit terminal in a similar manner to the one described above.

In this example, the connecting terminal 10D is part of wiring 33M between the connection point of the upper arm switching element 18G and the lower arm switching element 18H of the fourth half bridge circuit 19M, and the neutral point of the motor 8.

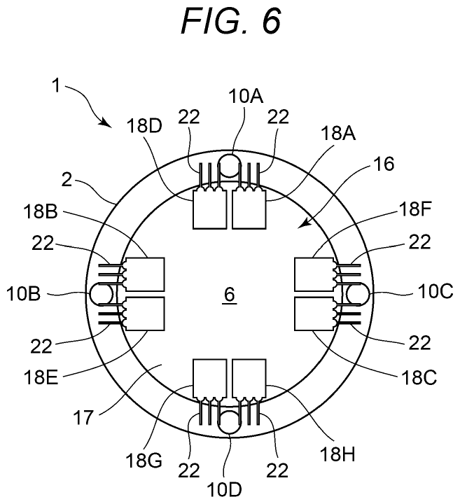

In addition, in the case of this example, the connecting terminals 10A, 10B, 10D, and 10C are dispersedly provided at equal intervals (spaced an angle of 90° apart around the axis of the housing 2) in the circumferential direction of the motor 8 (FIG. 6). In addition, also in this example, as illustrated in FIG. 6, the upper arm switching element 18A and the lower arm switching element 18D of the U-phase half bridge circuit 19U are located near the left and right sides of the connecting terminal 10A, and are placed in heat exchange relationship on the inverter accommodating portion 6-side surface of the partition wall 3.

Moreover, the upper arm switching element 18B and the lower arm switching element 18E of the V-phase half bridge circuit 19V of the inverter circuit 28 are located near the left and right sides of the connecting terminal 10B, and are placed in heat exchange relationship on the inverter accommodating portion 6-side surface of the partition wall 3. Furthermore, the upper arm switching element 18C and the lower arm switching element 18F of the W-phase half bridge circuit 19W of the inverter circuit 28 are located near the left and right sides of the connecting terminal 10C, and are placed in heat exchange relationship on the inverter accommodating portion 6-side surface of the partition wall 3.

In addition, the upper arm switching element 18G and the lower arm switching element 18H of the fourth half bridge circuit 19M of the inverter circuit 28 are located near the left and right sides of the connecting terminal 10D, and are placed in heat exchange relationship on the inverter accommodating portion 6-side surface of the partition wall 3. As described above, also in this example, the switching elements 18A to 18H are dispersedly placed in pairs, the pairs corresponding to the connecting terminals 10A to 10D respectively, and are provided on the partition wall 3. Moreover, the terminal portions 22 of the switching elements 18A to 18H are set upright toward the board 17, facing the connecting terminals 10A to 10D, and are electrically connected to the board 17 of the inverter 16.

As described above, the inverter 16 including the inverter circuit 28 is configured in such a manner as to supply power to the motor 8 via the connecting terminals 10A to 10D and the bus bar 5 also in this example. Moreover, the switching elements 18G and 18H are also in close contact with the partition wall 3 via a sheet for insulation and/or heat dissipation to have a heat exchange relationship with the partition wall 3 of the housing 2, and are cooled by the refrigerant sucked into the motor chamber 4 via the partition wall 3. The switching elements 18G and 18H themselves dissipate heat to the refrigerant via the partition wall 3. The rest are similar to the above-mentioned example.

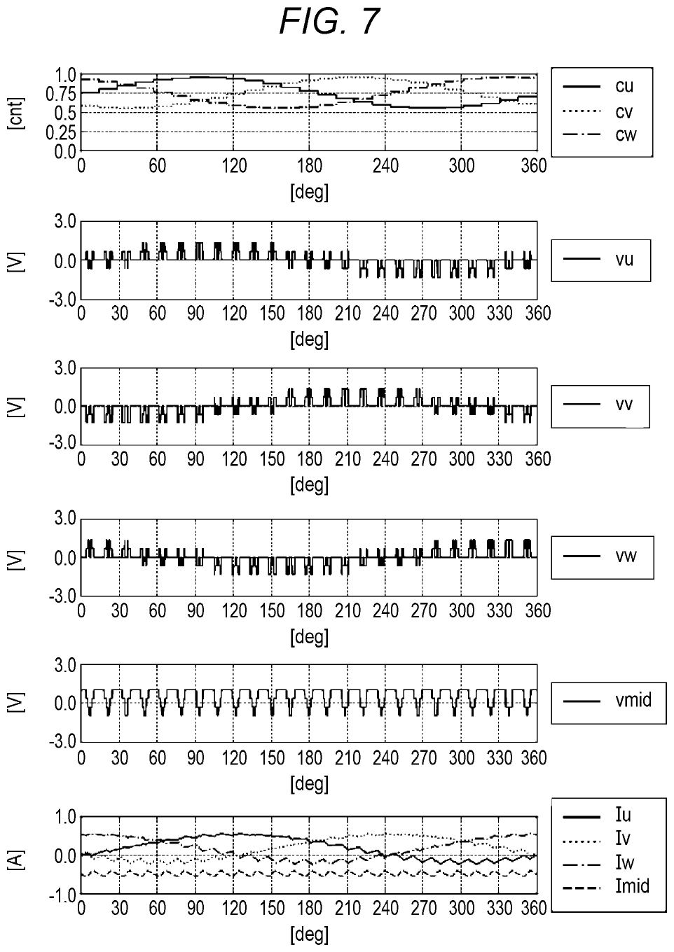

Next, FIG. 7 illustrates a control operation example of the control unit 21 of the inverter 16 in this example. In this drawing, cu, cv, and cw are normalized pulse width command values, and vu, vv, and vw are the voltages applied to the U, V, and W phases of the motor 8 respectively. Moreover, vmid is the neutral point voltage of the motor 8. Furthermore, Iu, Iv, and Iw are examples of the currents flowing through the motor 8.

Also in this case, the control unit 21 switches (ON/OFF) the switching elements 18A to 18F of the half bridge circuits 19U, 19V, and 19W of the phases of the inverter circuit 28 to apply the three-phase alternating current voltages vu, vv, and vw to the coils 9U, 9V, and 9W of the motor 8 respectively. The fourth half bridge circuit 19M always keeps the lower arm switching element 18H ON. Furthermore, all the pulse width command values cu, cv, and cw change PWM command values in such a manner that the ON times of the upper arm switching elements 18A to 18C are increased.

In the case of this example, it is possible to flow a DC current Imid through the exciting coil 34. The current is caused to flow through the exciting coil 34. Therefore, it is possible to provide a strong magnetic flux effect or a weak magnetic flux effect and to efficiently drive in a high-speed region and a low-speed region. Note that the directions of the current are as indicated in the electric circuit diagram of FIG. 5, and it is assumed that the currents are directed in such a manner that the sum is 0.

In addition, also in this example, the four connecting terminals 10A to 10D that are provided, protruding from the motor 8 in the direction of the partition wall 3, are dispersedly provided, and the switching elements 18A to 18H are dispersedly provided on the partition wall 3 in such a manner as to correspond to the connecting terminals 10A to 10D. Therefore, the values of the lengths (wiring lengths) of the wirings 33U to 33W and 33M to the phases and the neutral point of the motor 8 can be made the same or nearly the same. This makes it possible to equalize the surge voltages in the U, V, and W phases and the wiring to the neutral point and equalize the losses/heat generated of the switching elements 18A to 18H.

Moreover, also in this example, the switching elements 18A to 18H are provided in pairs on the partition wall 3 in such a manner that the pairs correspond to the connecting terminals 10A to 10D respectively, and are located near the connecting terminals 10A to 10D. Therefore, the wiring length from the switching elements 18A and 18D to the connecting terminal 10A, the wiring length from the switching elements 18B and 18E to the connecting terminal 10B, the wiring length from the switching elements 18C and 18F to the connecting terminal 10C, and the wiring length from the switching elements 18G and 18H to the connecting terminal 10D are reduced, and the surge voltages can be further reduced.

Moreover, also in this example, the connecting terminals 10A, 10B, 10D, and 10C are dispersedly provided at equal intervals in the circumferential direction of the motor 8. Therefore, it is possible to smoothly encourage the equalization of the wiring lengths to the U, V, and W phases and neutral point of the motor 8 (the lengths of the wirings 33U to 33W and 33M).

Furthermore, the degree of freedom in the placement of the switching elements 18A to 18H increases. Therefore, also if the number of connecting terminals increases to four, 10A to 10D, and the number of switching elements increases to eight, 18A to 18H, it is possible to place them in a state where the dielectric strength and the cooling efficiency are satisfied, without increasing the dimensions of the housing 2.

### Example 3

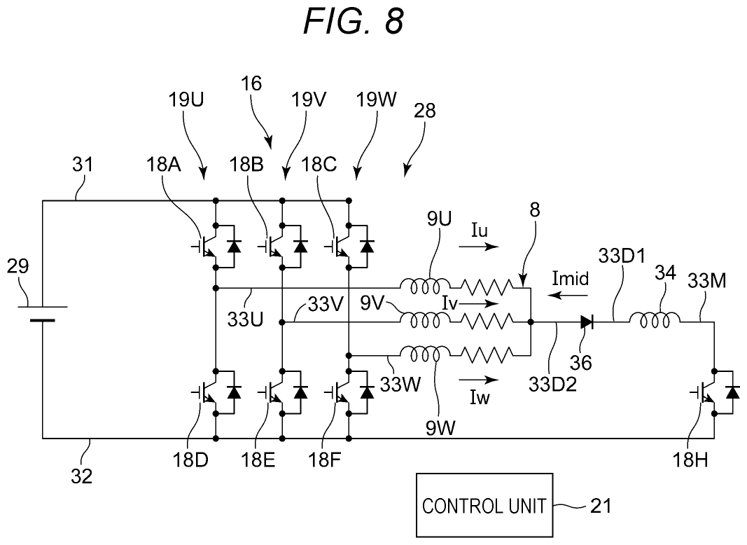

Next, still another example of the present invention is described with reference to FIGS. 8 to 10. Note that the structure of a target electric compressor 1 is similar to the one of FIG. 1, and those denoted by the same reference signs as those of FIGS. 1 to 7 are assumed to exert the same or similar functions. The inverter 16 of this example is also a four-wire inverter. However, the inverter circuit 28 is configured, including only the lower arm switching element 18H connected to the neutral point of the motor 8 through the exciting coil 34 via a diode 36 in contrast to the above-mentioned example (Example 2).

In other words, in this example, one more switching element 18H and the diode 36 are provided in addition to the six switching elements 18A to 18F (FIG. 8). In other words, the inverter circuit 28 of the inverter 16 of this example includes seven switching elements 18A to 18F and 18H in total, and further includes the diode 36. In this case, a collector electrode of the seventh switching element 18H is connected to the exciting coil 34, and an emitter electrode thereof is connected to the negative power supply line 32. In addition, the exciting coil 34 is connected to the neutral point of the motor 8 via the diode 36. Note that the forward direction of the diode 36 is set in the direction of the exciting coil 34.

As described above, the inverter 16 of this example includes the seven switching elements 18A to 18F and 18H and the diode 36. Therefore, also in terms of connecting terminals, three connecting terminals 10D, 10E, and 10F are provided in addition to the above-mentioned three connecting terminals 10A to 10C. Note that the connecting terminals 10D to 10F are also mounted on the bus bar 5, and one ends thereof are electrically connected to the motor 8 via the bus bar 5. Moreover, the connecting terminals 10D to 10F also protrude from the bus bar 5, pass through the similar insertion holes 15 in the partition wall 3 (penetrate the partition wall 3), and are electrically connected to the board 17 of the inverter 16 via, for example, press-fit terminals in a similar manner to the one described above.

In this example, the connecting terminal 10D is part of the wiring 33M between the collector electrode of the lower arm switching element 18H and the exciting coil 34, the connecting terminal 10E is part of wiring 33D1 between the exciting coil 34 and the diode 36, and the connecting terminal 10F is part of wiring 33D2 between the diode 36 and the neutral point of the motor 8.

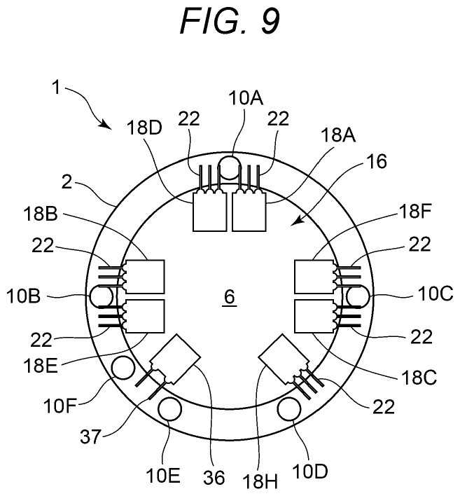

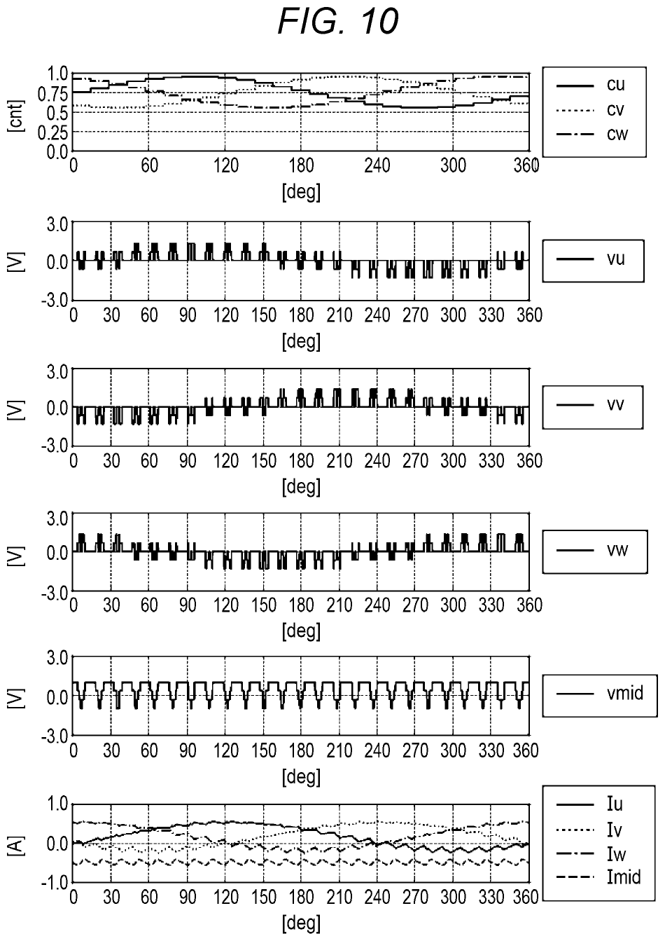

In addition, in the case of this example, the connecting terminals 10A, 10B, 10F, 10E, 10D, and 10C are dispersedly provided in the circumferential direction of the motor 8 (FIG. 9). In addition, also in this example, as illustrated in FIG. 9, the upper arm switching element 18A and the lower arm switching element 18D of the U-phase half bridge circuit 19U are located near the left and right sides of the connecting terminal 10A, and are placed in heat exchange relationship on the inverter accommodating portion 6-side surface of the partition wall 3.

Moreover, the upper arm switching element 18B and the lower arm switching element 18E of the V-phase half bridge circuit 19V of the inverter circuit 28 are located near the left and right sides of the connecting terminal 10B, and are placed in heat exchange relationship on the inverter accommodating portion 6-side surface of the partition wall 3. Furthermore, the upper arm switching element 18C and the lower arm switching element 18F of the W-phase half bridge circuit 19W of the inverter circuit 28 are located near the left and right sides of the connecting terminal 10C, and are placed in heat exchange relationship on the inverter accommodating portion 6-side surface of the partition wall 3.

In addition, the seventh lower arm switching element 18H of the inverter circuit 28 is located near the connecting terminal 10D, and is placed in heat exchange relationship on the inverter accommodating portion 6-side surface of the partition wall 3. Moreover, the diode 36 is located between and near the connecting terminals 10E and 10F, and is placed in heat exchange relationship on the inverter accommodating portion 6-side surface of the partition wall 3.

As described above, also in this example, the switching elements 18A to 18F are dispersedly placed in pairs, the pairs corresponding to the connecting terminals 10A to 10C respectively, and are provided on the partition wall 3. Moreover, the terminal portions 22 of the switching elements 18A to 18F and 18H and a terminal 37 of the diode 36 are set upright toward the board 17, facing the connecting terminals 10A to 10F, and are electrically connected to the board 17 of the inverter 16.

As described above, also in this example, the inverter 16 including the inverter circuit 28 is configured in such a manner as to supply power to the motor 8 via the connecting terminals 10A to 10F and the bus bar 5. Moreover, the switching element 18H and the diode 36 are also in close contact with the partition wall 3 via a sheet for insulation and/or heat dissipation to have a heat exchange relationship with the partition wall 3 of the housing 2, and are cooled by the refrigerant sucked into the motor chamber 4 via the partition wall 3. The switching element 18H and the diode 36 themselves dissipate heat to the refrigerant via the partition wall 3. The rest are similar to the above-mentioned example.

Next, FIG. 10 illustrates a control operation example of the control unit 21 of the inverter 16 in this example. In this drawing, cu, cv, and cw are normalized pulse width command values, and vu, vv, and vw are the voltages applied to the U, V, and W phases of the motor 8 respectively. Moreover, vmid is the neutral point voltage of the motor 8. Furthermore, Iu, Iv, and Iw are examples of the currents flowing through the motor 8.

Also in this case, the control unit 21 switches (ON/OFF) the switching elements 18A to 18F of the half bridge circuits 19U, 19V, and 19W of the phases of the inverter circuit 28 to apply the three-phase alternating current voltages vu, vv, and vw to the coils 9U, 9V, and 9W of the motor 8 respectively. On the other hand, the lower arm switching element 18H connected to the exciting coil 34 is always kept ON. Moreover, assuming that the definition of the current of the motor 8 is the flow-in direction, a negative current flows as the DC current Imid. The rest are similar to the case of Example 2 above.

Also in this example, the six connecting terminals 10A to 10F that are provided, protruding from the motor 8 in the direction of the partition wall 3, are dispersedly provided, and the switching elements 18A to 18F and 18H and the diode 36 are dispersedly provided on the partition wall 3 in such a manner as to correspond to the connecting terminals 10A to 10F. Therefore, the values of the lengths (wiring lengths) of the wirings 33U to 33W, 33M, 33D1, and 33D2 to the phases and neutral point of the motor 8 can be made the same or nearly the same. This makes it possible to equalize the surge voltages in the U, V, and W phases and the wirings to the neutral point and equalize the losses/heat generated of the switching elements 18A to 18F and 18H, and the diode 36.

Moreover, also in this example, the switching elements 18A to 18F are provided in pairs on the partition wall 3 in such a manner that the pairs correspond to the connecting terminals 10A to 10C respectively, and are located near the connecting terminals 10A to 10C. In addition, the switching element 18H is provided on the partition wall 3 in such a manner as to correspond to the connecting terminal 10D and be located near the connecting terminal 10D. The diode 36 is provided on the partition wall 3 in such a manner as to correspond to the connecting terminals 10E and 10F and be located near the connecting terminals 10E and 10F. Therefore, the wiring length from the switching elements 18A and 18D to the connecting terminal 10A, the wiring length from the switching elements 18B and 18E to the connecting terminal 10B, the wiring length from the switching elements 18C and 18F to the connecting terminal 10C, the wiring length from the switching element 18H to the connecting terminal 10D, and the wiring length from the diode 36 to the connecting terminals 10E and 10F are reduced, and the surge voltages can be further reduced.

Moreover, the degree of freedom in the placement of the switching elements 18A to 18F and 18H, and the diode 36 increases. Therefore, also if the number of connecting terminals increases to six, 10A to 10F, the number of switching elements increases to seven, 18A to 18F and 18H, and the diode 36 is added, it is possible to place them in a state where the dielectric strength and the cooling efficiency are satisfied, without increasing the dimensions of the housing 2.

### Example 4

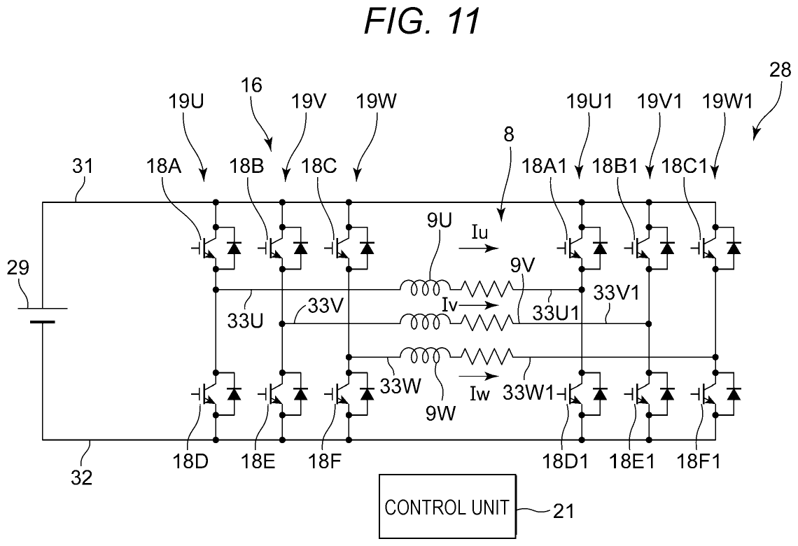

Next, yet another example of the present invention is described with reference to FIGS. 11 to 13. Note that the structure of a target electric compressor 1 is similar to the one of FIG. 1, and those denoted by the same reference signs as those of FIGS. 1 to 10 are assumed to exert the same or similar functions. The inverter 16 of this example is a six-wire inverter, and the inverter circuit 28 includes three more half bridge circuits 19U1, 19V1, and 19W1 corresponding to the U, V, and W phases respectively, in addition to the half bridge circuits 19U to 19W (FIG. 11). In addition, the half bridge circuits 19U to 19W and the half bridge circuits 19U1 to 19W1 are opposed to each other across the coils 9U to 9W of the motor 8 without bundling the phases of the motor 8 for a neutral point.

In this case, the half bridge circuits 19U1 to 19W1 of the phases also individually include upper arm switching element 18A1 to 18C1 and lower arm switching element 18D1 to 18F1. Moreover, each of the switching elements 18A1 to 18F1 also incorporates a flywheel diode connected in anti-parallel thereto. Moreover, collector electrodes of the upper arm switching elements 18A1 to 18C1 are connected to the positive power supply line 31 of the direct current power supply 29. On the other hand, emitter electrodes of the lower arm switching elements 18D1 to 18F1 are connected to the negative power supply line 32 of the direct current power supply 29.

In addition, an emitter electrode of the upper arm switching element 18A1 and a collector electrode of the lower arm switching element 18D1 of the U-phase half bridge circuit 19U1 are connected together, and their connection point (an arm midpoint) is connected to the other end of the U-phase coil 9U of the motor 8. Moreover, an emitter electrode of the upper arm switching element 18B1 and a collector electrode of the lower arm switching element 18E1 of the V-phase half bridge circuit 19V1 are connected together, and their connection point (an arm midpoint) is connected to the other end of the V-phase coil 9V of the motor 8. Furthermore, an emitter electrode of the upper arm switching element 18C1 and a collector electrode of the lower arm switching element 18F1 of the W-phase half bridge circuit 19W1 are connected together, and their connection point (an arm midpoint) is connected to the other end of the W-phase coil 9W of the motor 8.

As described above, the inverter 16 of this example includes 12 switching elements 18A to 18F and 18A1 to 18F1 in total. Therefore, also in terms of connecting terminals, three more connecting terminals 10D to 10F are provided in addition to the above-mentioned three connecting terminals 10A to 10C (six in total). Note that the connecting terminals 10D to 10F are also mounted on the bus bar 5, and one ends thereof are electrically connected to the motor 8 via the bus bar 5. Moreover, the connecting terminals 10D to 10F also protrude from the bus bar 5, pass through the similar insertion holes 15 in the partition wall 3 (penetrate the partition wall 3), and are electrically connected to the board 17 of the inverter 16 via, for example, press-fit terminals in a similar manner to the one described above.

In this example, the connecting terminal 10D is part of wiring 33U1 between the connection point of the upper arm switching element 18A1 and the lower arm switching element 18D1 of the half bridge circuit 19U1, and the other end of the U-phase coil 9U of the motor 8. Moreover, the connecting terminal 10E is part of wiring 33V1 between the connection point of the upper arm switching element 18B1 and the lower arm switching element 18E1 of the half bridge circuit 19V1, and the other end of the V-phase coil 9V of the motor 8. Furthermore, the connecting terminal 10F is part of wiring 33W1 between the connection point of the upper arm switching element 18C1 and the lower arm switching element 18F1 of the half bridge circuit 19W1, and the other end of the W-phase coil 9W of the motor 8.

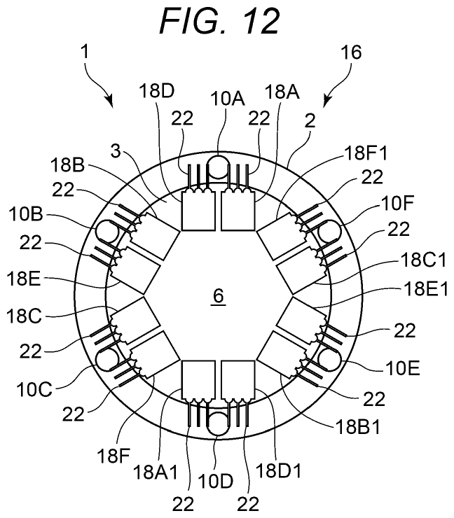

In addition, in the case of this example, the connecting terminals 10A to 10F are dispersedly provided at equal intervals (spaced an angle of 60° apart around the axis of the housing 2) in the circumferential direction of the motor 8 (FIG. 12). In addition, also in this example, as illustrated in FIG. 12, the upper arm switching element 18A and the lower arm switching element 18D of the U-phase half bridge circuit 19U are located near the left and right sides of the connecting terminal 10A, and are placed in heat exchange relationship on the inverter accommodating portion 6-side surface of the partition wall 3.

Moreover, the upper arm switching element 18B and the lower arm switching element 18E of the V-phase half bridge circuit 19V of the inverter circuit 28 are located near the left and right sides of the connecting terminal 10B, and are placed in heat exchange relationship on the inverter accommodating portion 6-side surface of the partition wall 3. Furthermore, the upper arm switching element 18C and the lower arm switching element 18F of the W-phase half bridge circuit 19W of the inverter circuit 28 are located near the left and right sides of the connecting terminal 10C, and are placed in heat exchange relationship on the inverter accommodating portion 6-side surface of the partition wall 3.

In addition, the upper arm switching element 18A1 and the lower arm switching element 18D1 of the other U-phase half bridge circuit 19U1 are located near the left and right sides of the connecting terminal 10D, and are placed in heat exchange relationship on the inverter accommodating portion 6-side surface of the partition wall 3. Moreover, the upper arm switching element 18B1 and the lower arm switching element 18E1 of the other V-phase half bridge circuit 19V1 are located near the left and right sides of the connecting terminal 10E, and are placed in heat exchange relationship on the inverter accommodating portion 6-side surface of the partition wall 3. Furthermore, the upper arm switching element 18C1 and the lower arm switching element 18F1 of the other W-phase half bridge circuit 19W1 are located near the left and right sides of the connecting terminal 10F, and are placed in heat exchange relationship on the inverter accommodating portion 6-side surface of the partition wall 3.

As described above, also in this example, the switching elements 18A to 18F and 18A1 to 18F1 are dispersedly placed in pairs, the pairs corresponding to the connecting terminals 10A to 10F respectively, and are provided on the partition wall 3. Moreover, the terminal portions 22 of the switching elements 18A to 18F and 18A1 to 18F1 are set upright toward the board 17, facing the connecting terminals 10A to 10F, and are electrically connected to the board 17 of the inverter 16.

As described above, also in this example, the inverter 16 including the inverter circuit 28 is configured in such a manner as to supply power to the motor 8 via the connecting terminals 10A to 10F and the bus bar 5. Moreover, the switching elements 18A1 to 18F1 are also in close contact with the partition wall 3 via a sheet for insulation and/or heat dissipation to have a heat exchange relationship with the partition wall 3 of the housing 2, and are cooled by the refrigerant sucked into the motor chamber 4 via the partition wall 3. The switching elements 18A1 to 18F1 themselves dissipate heat to the refrigerant via the partition wall 3. The rest are similar to the above-mentioned example.

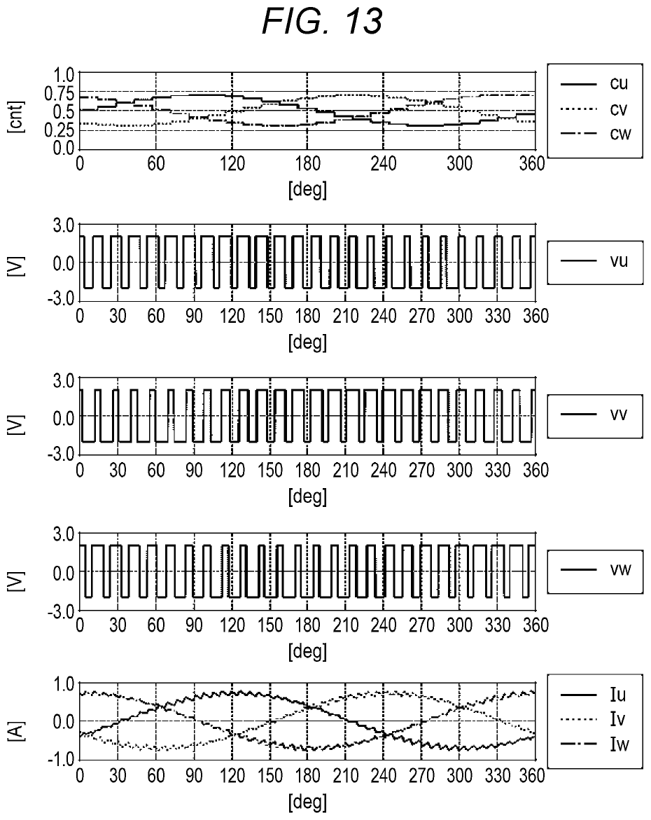

Next, FIG. 13 illustrates a control operation example of the control unit 21 of the inverter 16 in this example. In this drawing, cu, cv, and cw are normalized pulse width command values, and vu, vv, and vw are the voltages applied to the U, V, and W phases of the motor 8 respectively. Moreover, Iu, Iv, and Iw are examples of the currents flowing through the motor 8.

Also in this case, the control unit 21 switches (ON/OFF) the switching elements 18A to 18F of the half bridge circuits 19U, 19V, and 19W of the phases of the inverter circuit 28 to apply the three-phase alternating current voltages vu, vv, and vw to the coils 9U, 9V, and 9W of the motor 8 respectively. On the other hand, the operations of the upper arm switching elements 18A1 to 18C1 of the half bridge circuits 19U1, 19V1, and 19W1 of the phases are operated in a reverse manner. In other words, when the upper arm switching element 18A of the half bridge circuit 19U is ON, the lower arm switching element 18D1 of the opposing half bridge circuit 19U1 is turned ON.

As a result, the voltages to be applied to the U-, V-, W-phase coils 9U to 9W of the motor 8 can be applied in a range of plus and minus two, and an approximately doubled voltage can be applied even in a simple operation when it is judged from amplitude. Note that the maximum voltage that can be applied is approximately 1.5 times to 2 times (specific numerical values vary depending on the modulation method).

In addition, also in this example, the six connecting terminals 10A to 10F that are provided, protruding from the motor 8 in the direction of the partition wall 3, are dispersedly provided, and the switching elements 18A to 18F and 18A1 to 18F1 are dispersedly provided on the partition wall 3 in such a manner as to correspond to the connecting terminals 10A to 10F. Therefore, the values of the lengths (wiring lengths) of the wirings 33U to 33W and 33U1 to 33W1 to the phases of the motor 8 can be made the same or nearly the same. This makes it possible to equalize the surge voltages in the wirings to the U, V, and W phases and equalize the losses/heat generated of the switching elements 18A to 18F and 18A1 to 18F1.

Moreover, also in this example, the switching elements 18A to 18F and 18A1 to 18F1 are provided in pairs on the partition wall 3 in such a manner that the pairs correspond to the connecting terminals 10A to 10F respectively, and are located near the connecting terminals 10A to 10F. Therefore, the wiring length from the switching elements 18A and 18D to the connecting terminal 10A, the wiring length from the switching elements 18B and 18E to the connecting terminal 10B, the wiring length from the switching elements 18C and 18F to the connecting terminal 10C, the wiring length from the switching elements 18A1 and 18D1 to the connecting terminal 10D, the wiring length from the switching elements 18B1 and 18E1 to the connecting terminal 10E, and the wiring length from the switching elements 18C1 and 18F1 to the connecting terminal 10F are reduced, and the surge voltages can be further reduced.

Moreover, also in this example, the connecting terminals 10A to 10F are dispersedly provided at equal intervals in the circumferential direction of the motor 8. Therefore, it is possible to smoothly encourage the equalization of the wiring lengths to the U, V, and W phases of the motor 8 (the lengths of the wirings 33U to 33W and 33U1 to 33W1).

Furthermore, the degree of freedom in the placement of the switching elements 18A to 18F and 18A1 to 18F1 increases. Therefore, also if the number of connecting terminals increases to six, 10A to 10F, and the number of switching elements increases to 12, 18A to 18F and 18A1 to 18F1, it is possible to place them in a state where the dielectric strength and the cooling efficiency are satisfied, without increasing the dimensions of the housing 2. Consequently, it is possible to adopt the inverter 16 such as the inverter circuit 28 of FIG. 11, and it is also possible to smoothly widen the voltage range.

Note that a switching element including an IGBT has been described in the examples. However, a MOSFET may be used. Moreover, the specific configuration is not limited to those presented in the examples, and the specific configurations presented in the examples can be changed within the scope that does not depart from the purport of the present invention.

### LIST OF REFERENCE SIGNS

1 Electric compressor
2 Housing
3 Partition wall
4 Motor chamber
5 Bus bar
6 Inverter accommodating portion
7 Compression mechanism
8 Motor
9 Stator
10A to 10F Connecting terminal
16 Inverter
17 Board
18A to 18H, 18A1 to 18F1 Switching element
19U, 19U1 U-phase inverter
19V, 19V1 V-phase inverter
19W, 19W1 W-phase inverter
21 Control unit
28 Inverter circuit
36 Diode

1. An electric compressor including an inverter that has a plurality of switching elements and supplies power to a motor, the electric compressor comprising:
a housing including a motor chamber in which the motor is incorporated, and an inverter accommodating portion in which the inverter is mounted;
a partition wall between the motor chamber and the inverter accommodating portion; and
a plurality of connecting terminals each having one end electrically connected to the motor and protruding from the motor in a direction of the partition wall, wherein
the connecting terminals are dispersedly provided and each have the other end electrically connected to the inverter through the partition wall, and
the switching elements are dispersedly provided on the partition wall in such a manner as to correspond to each of the connecting terminals.

2. The electric compressor according to claim 1, wherein the switching elements are located near the connecting terminals and provided on the partition wall.

3. The electric compressor according to claim 1, wherein the connecting terminals are dispersedly provided at equal intervals in a circumferential direction of the motor.

4. The electric compressor according to claim 1, wherein
three connecting terminals are provided,
the inverter includes six switching elements, and
the switching elements are placed in pairs, the pairs corresponding to the connecting terminals respectively.

5. The electric compressor according to claim 1, wherein
four connecting terminals are provided,
the inverter includes eight switching elements, and
the switching elements are placed in pairs, the pairs corresponding to the connecting terminals respectively.

6. The electric compressor according to claim 1, wherein
six connecting terminals are provided,
the inverter includes seven switching elements and one diode, and
the switching elements and the diode are dispersedly placed in such a manner as to correspond to each of the connecting terminals.

7. The electric compressor according to claim 1, wherein
six connecting terminals are provided,
the inverter includes 12 switching elements, and
the switching elements are placed in pairs, the pairs corresponding to each of the connecting terminals respectively.
